(19) United States
(12) Patent Application Publication
(10) Pub. No.: US 2015/0329027 A1
(43) Pub. Date: Nov. 19, 2015

(54) SEAT CONDITIONING ASSEMBLY INCLUDING A NOISE SUPPRESSOR

(71) Applicant: Dmitri Axakov, Windsor (CA)

(72) Inventor: Dmitri Axakov, Windsor (CA)

(73) Assignee: IGB AUTOMOTIVE LTD., Windsor (CA)

(21) Appl. No.: 14/708,345

(22) Filed: May 11, 2015

Related U.S. Application Data
(60) Provisional application No. 61/993,618, filed on May 15, 2014.

(51) Int. Cl. B60N 2/56; A47C 7/00

(52) U.S. Cl. CPC B60N 2/5621; A47C 7/00

(57) ABSTRACT

A seat conditioning assembly in accordance with the invention includes a ventilation diffuser bag having an A-side and an opposite B-side. An air mover is connected to the B-side of the ventilation diffuser bag. A noise suppressor is disposed adjacent the A-side of the ventilation diffuser bag. The noise suppressor overlaps a location of the air mover in a direction from the A-side to the B-side.

### CROSS REFERENCE TO RELATED APPLICATION

This application claims the priority of U.S. Provisional Application No. 61/993,618 filed May 15, 2014.

### TECHNICAL FIELD

This invention relates to the field of comfort systems for occupant supports, and more particularly to a seat conditioning assembly for vehicular and non-vehicular seating comfort systems.

### BACKGROUND OF THE INVENTION

Seats with ventilating systems have become a frequently employed feature in transportation vehicles and now also in furniture and hospital seating and bedding. Conventional ventilated seats include a seat trim cover made of fabric, leather, or perforated leather on which a seat occupant's body rests, and an air permeable layer located under the seat cover. The air permeable layer is disposed on a cushioning element, for example a bun of polyurethane foam, coconut fiber, cotton mat, etc. The cushioning element of the seat is typically supported by a seat structure including a frame that may be stationary or flexing. Examples of the supporting structure include steel springs, plywood sheeting, a “seat pan” or metal frame (in automotive seats), and other structural materials. At least one air mover, for example one or more fans, blowers or other air delivery systems (e.g., a vehicular air conditioning unit) push or pull air to or from the occupant support surface of the seat cushion and/or the seat back (backrest) of the seat through the air permeable layer by providing air pressure or a partial vacuum. The air movers may be reversible, and in the case of “pushing” the air, the air may be conditioned, i.e., cooled, warmed, dried, moisturized, etc. In one arrangement, the foam bun of the seat cushion and/or seat back includes one of more through holes that provide a conduit through which air can travel from the front, occupant contact side (A-side) of the seat to the back/rear (B-side) of the seat. The air mover(s) may be disposed within or adjacent to the through holes in the foam bun, or may be disposed on the rear, B-side of the seat, and are in fluid communication with the through holes.

Modern, energy-efficient vehicles may have thinner foam pads (foam buns) in the seat cushion and seat back of the occupant support. This type of seat may have insufficient noise muffling and vibration suppression properties, which leads to undesirable noise and vibration during operation of an active seat ventilation system. In an attempt to reduce noise and vibration, some ventilated seats include corrugated or curved air ducts. Alternatively, a weight may be added to the air moving housing, the air intake of the fan/blower may be moved away from the seat occupant, or a noise shield may be provided to shield the fan/blower. However, these noise and vibration prevention measures have limited effectiveness, require additional space for installation, and increase costs.

### SUMMARY OF THE INVENTION

The present invention provides a seat conditioning assembly for use with occupant supports such as vehicle seats. The seat conditioning assembly includes a noise suppressor that suppresses air mover noise and vibration. The seat conditioning assembly thereby provides ventilation and conditioning for the seat occupant in a quieter and less distracting manner.

More particularly, a seat conditioning assembly in accordance with the invention includes a ventilation diffuser bag having an A-side and an opposite B-side. An air mover is in fluid communication with the B-side of the ventilation diffuser bag. A noise suppressor is disposed adjacent the A-side of the ventilation diffuser bag. The noise suppressor overlaps a location of the air mover in a direction from the A-side to the B-side.

The noise suppressor may be mounted inside the ventilation diffuser bag. Alternatively, the noise suppressor may be mounted on an outer surface of the ventilation diffuser bag, or may be integral with the A-side of the ventilation diffuser bag. The noise suppressor may be formed by applying a noise suppression material in liquid form to a portion of the A-side of the ventilation diffuser bag, followed by hardening, setting, or polymerization of the noise suppression material. The noise suppressor may be a planar member. The noise suppressor may include a plurality of sublayers. The sublayers may include polyurethane film. The noise suppressor may include three 180×180 mm polyurethane film sublayers each having a thickness of 1 mm and having a matte surface, and the noise suppressor may have an equivalent density of 3.5 kg/m². The noise suppressor may include alternating sublayers of a high density material and a felt or fabric layer. The high density material may be one or more of steel, rubber, linoleum, elastomer foil, a mineral-filled elastomer, and polyurethane.

The air mover may be connected to the B-side of the ventilation diffuser bag.

A seating comfort system in accordance with the invention includes a seat cushion having an occupant facing side and an opposite rear facing side. A ventilation diffuser bag is disposed on the rear facing side of the seat cushion. An air mover is connected to the ventilation diffuser bag. A noise suppressor is disposed intermediate the rear facing side of the seat cushion and the air mover. The noise suppressor overlaps a location of the air mover in a direction from the occupant facing side of the seat cushion to the rear facing side of the seat cushion.

The noise suppressor may be mounted on an outer surface of the ventilation diffuser bag. The noise suppressor may be mounted inside the ventilation diffuser bag. The noise suppressor may be integral with the A-side of the ventilation diffuser bag. The noise suppressor may be mounted on the rear facing side of the seat cushion. The noise suppressor may have a greater density per unit area than other members of the seating comfort system. The noise suppressor may include one or more of steel, rubber, linoleum, elastomer foil, a mineral-filled elastomer, and polyurethane. The ventilation diffuser bag may be mounted either the occupant facing side or the rear facing side of the seat cushion.

These and other features and advantages of the invention will be more fully understood from the following detailed description of the invention taken together with the accompanying drawings.

### BRIEF DESCRIPTION OF THE DRAWINGS

In the drawings:

FIG. 1 is a cross-sectional view of a vehicle seat including a seat conditioning assembly in accordance with an embodiment of the invention;

FIG. 1A is an enlarged view of a portion of FIG. 1 illustrating an air mover and noise suppressor of the assembly;

FIG. 2 is an environment view of a vehicle seat including a seat conditioning assembly in accordance with another embodiment of the invention illustrating the seat conditioning assembly in cross section;

FIG. 3 is an exploded view of a seat conditioning assembly in accordance with yet another embodiment of the invention;

FIG. 4 is an exploded view of a seat conditioning assembly in accordance with yet another embodiment of the invention;

FIG. 5 is an exploded, sectional view of a seat conditioning assembly in accordance with yet another embodiment of the invention;

FIG. 6 is an exploded, sectional view of a seat conditioning assembly in accordance with yet another embodiment of the invention, illustrating the flow of air towards the seat occupant;

FIG. 7 is a cross-sectional view of a vehicle seat including a seat conditioning assembly in accordance with yet another embodiment of the invention;

FIG. 7A is an enlarged view of a portion of FIG. 7 illustrating a noise suppressor of the assembly;

FIG. 7B is another enlarged view of a portion of FIG. 7 illustrating an alternative disposition of the noise suppressor of the assembly;

FIG. 7C is yet another enlarged view of a portion of FIG. 7 illustrating an alternative noise suppressor of the assembly;

FIG. 8 is a cross-sectional view of a vehicle seat including a seat conditioning assembly in accordance with yet another embodiment of the invention;

FIG. 8A is an enlarged view of a portion of FIG. 8 illustrating a noise suppressor of the assembly;

FIG. 8B is another enlarged view of a portion of FIG. 8 illustrating an alternative disposition of the noise suppressor of the assembly;

FIG. 8C is yet another enlarged view of a portion of FIG. 8 illustrating an alternative noise suppressor of the assembly; and

FIG. 9 is an exploded, sectional view of the seat conditioning assembly of FIG. 8.

### DETAILED DESCRIPTION OF THE INVENTION

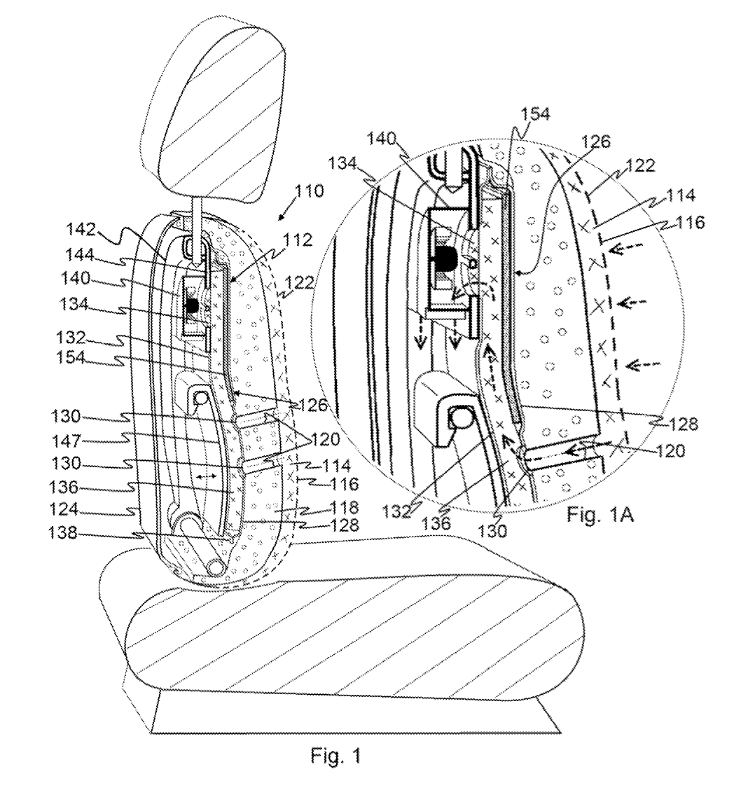

Referring now to the drawings in detail and particularly to FIG. 1, numeral 110 generally indicates a seating comfort system including a seat conditioning assembly 112 in accordance with an embodiment of the invention. In the further embodiments disclosed, like reference numbers represent like or similar parts as those of the first embodiment 110. The seating comfort system 110 includes a layer 114 of air-permeable material (spacer material, foam, or the like) between the outer trim cover layer 116 (fabric, perforated leather, or the like) and the cushioning element 118 (e.g., polyurethane foam bun or similar) of the seat. The layer of air-permeable material 114 includes voids that provide open space for the free flow of air throughout the material. The foam bun 118 includes a plurality of through holes 120 (i.e., air passages, conduits) that extend from an occupant facing side (A-side) 122 of the seat to an opposite rear side (B-side) 124 of the seat. The trim cover 116 may be a permeable material or an impermeable material having one or more perforated, air permeable portions or zones. The trim cover 116 is in fluid communication with the through holes 120 via the air-permeable material layer 114.

The seat conditioning assembly 112 of the seating comfort system 110 includes a ventilation diffuser bag 126 (vent deflector) having an occupant facing side 128 (A-side) including a one or more openings 130 (e.g., a single air vent or a plurality of air vents), and an opposite rear facing side 132 (B-side) having an air mover port 134. The sides 128, 132 of the diffuser bag 126 may be made of a plastic material such as a urethane material or similar, a fabric material such as a woven or non-woven polyester, a felt material, or other similar material. The diffuser bag sides may be generally impermeable aside from the aforementioned openings and port formed therein. Alternatively, one or both of the diffuser bag sides may be generally permeable (either porous or perforated). A layer of air-permeable spacer material 136 is disposed between the sides 128, 132 of the diffuser bag. The spacer material 136 may be an air-permeable fabric or other similar structure that includes voids providing open space that allows for an even distribution of air throughout the diffuser bag, but resists mechanical collapse under mechanical pressure exerted by the seat occupant. Known spacer materials include a single polymer or metal layer with periodic openings, two layers including openings and being spaced apart by studs or similar, such as two honeycomb layers spaced apart by polymeric strands or similar. The spacer material 136 may have the same or similar construction as the air-permeable material layer 114 on the front, A-side of the seat. The sides 128, 132 of the diffuser bag 126 are sealed along a peripheral edge 138 by an adhesive, by welding, or by any other suitable bonding method, to envelope the spacer material 136 within the diffuser bag.

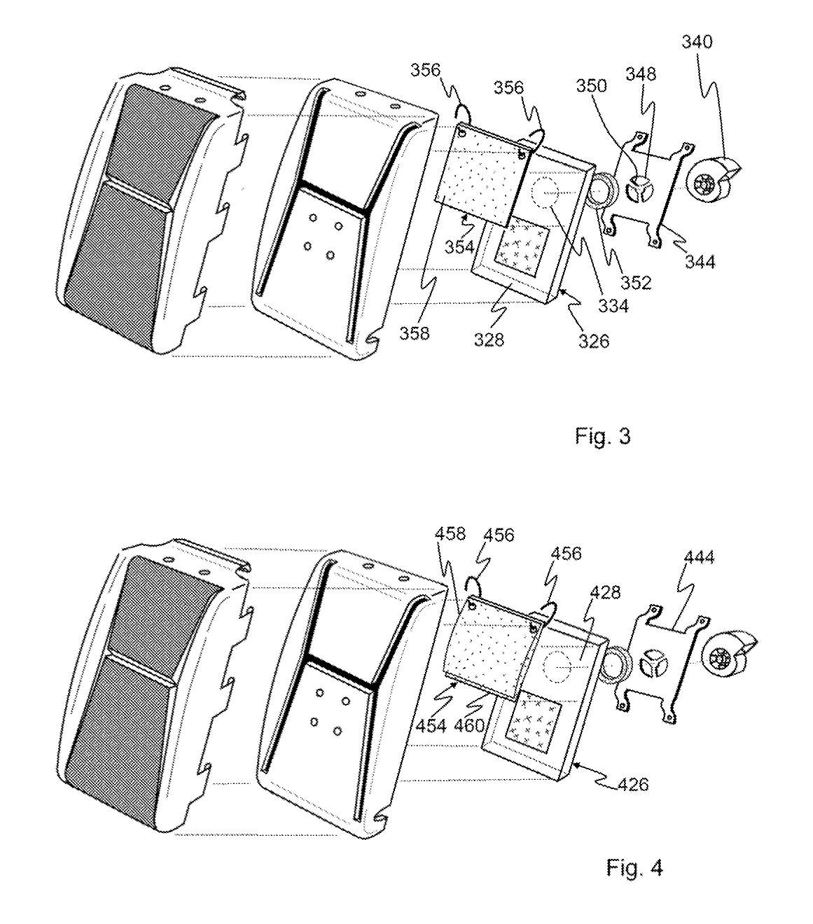

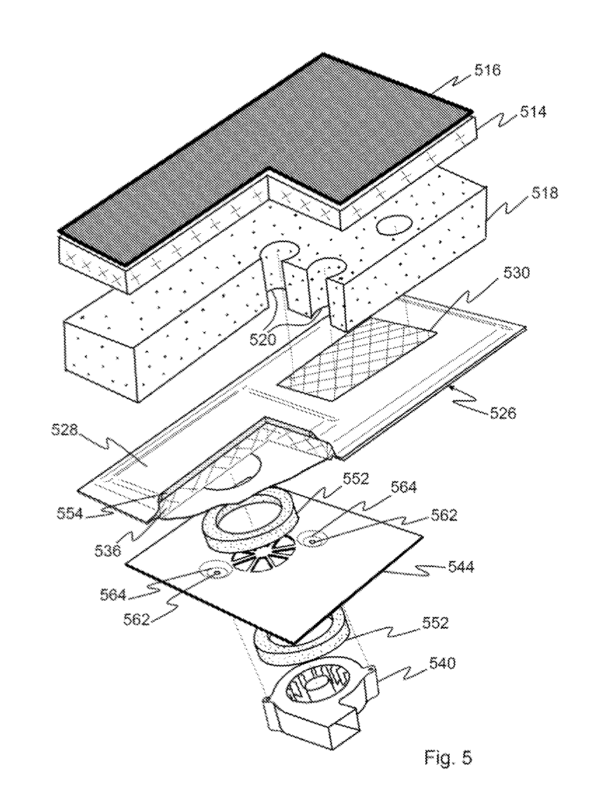

An air mover 140 is mounted on or adjacent the rear facing side 132 of the diffuser bag 126 around the air mover port 134 and is in fluid communication with the air mover port. The air mover 140 may be a fan or blower (e.g., a radial blower or axial fan blower) or other similar device capable of creating a flow of air. In one embodiment, the air mover 140 may be directly or indirectly mounted to a portion of the seat frame in proximity to or directly adjacent the diffuser bag 126, and may be directly in fluid communication with the air mover port or via an air duct or other similar air passage or conduit connected between the air mover and the air mover port in the diffuser bag. For example, as shown for example in FIG. 1, the air mover 140 may be mounted on the metal frame 142 of the seat via a mounting bracket 144. Alternate mounting brackets 344, 444, 544, 644 are shown in FIGS. 3 through 6. Also, as shown in FIG. 6, the air mover (not shown) may be connected to the mounting bracket 644 via a conduit 646. The mounting bracket 144 is fastened to the seat frame 142. Alternatively, the mounting bracket may be mounted to the adjustable lumbar support moveable “plate” 147 or to the bars on which the lumbar support moveable “plate” is mounted on. In an embodiment, the mounting bracket 344 in FIG. 3 includes an air port 348, and the air mover 340 is connected to the mounting bracket such that it is aligned with the air port. The mounting bracket air port 348 is also aligned with the air mover port 334 in the diffuser bag 326. The mounting bracket air port 348 includes a grill 350 or “finger guard” that prevents sagging of the diffuser bag 326 into the mounting bracket air port. Alternatively, the grill or “finger guard” may be part of the blower housing or may be a member that is separate from the mounting bracket and the blower housing. An annular gasket 352 may be disposed between the mounting bracket 348 and the diffuser bag 326 around the mounting bracket air port 348 and the air mover port 334 in the diffuser bag. The annular gasket 352 may be made of a polymer foam or may be a polymer bellows. The annular gasket may not be included if the diffuser bag sufficiently contacts the mounting bracket, at least when the seat is occupied by an occupant. The coupling of the diffuser bag and air mover mounting bracket (with or with the annular gasket) allows for some misalignment during assembly without significantly reducing the functionality of the system. In another embodiment depicted in FIG. 5, an annular gasket 552 is disposed between the mounting bracket 544 and the diffuser bag 526 and another annular gasket 552 is disposed between the mounting bracket and the air mover 540.

The diffuser bag 126 is mounted on the rear, B-side 124 of the foam bun 118 between the foam bun and the structural support 142 of the seat, with the occupant facing side 128 of the diffuser bag facing the foam bun. The one or more openings 130 in the occupant facing side of the diffuser bag are aligned with the through holes 120 in the foam bun. Thus, the air mover 140 and the spacer material 136 within the diffuser bag on the rear, B-side of the seat are in fluid communication with the air-permeable material 114 and trim cover 116 on the occupant facing, A-side 122 of the seat via the opening(s) in the diffuser bag and the through holes in the foam bun. During operation, the air mover may either suck air from the occupant facing side of the seat or blow air to the occupant facing side. As shown by arrows in FIG. 1A, the air mover 140 draws air from the occupant facing side 122 of the seat through the perforations/openings in the trim cover 116 into the air-permeable material 114. The air travels through the air-permeable material into the through holes 120 in the foam bun and then into the diffuser bag 126 via the opening(s) 130 on the occupant facing side 128 of the diffuser bag. The air then passes through the spacer material 136 in the bag and into the housing of the air mover 140 through the air mover port 134 in the rear facing side 132 of the diffuser bag. The air is then finally blown out of an opening in the housing of the air mover. The air flow removes heat and/or moisture from the occupant facing side of the seat, thereby providing cooling of an occupant that is seated in the seat.

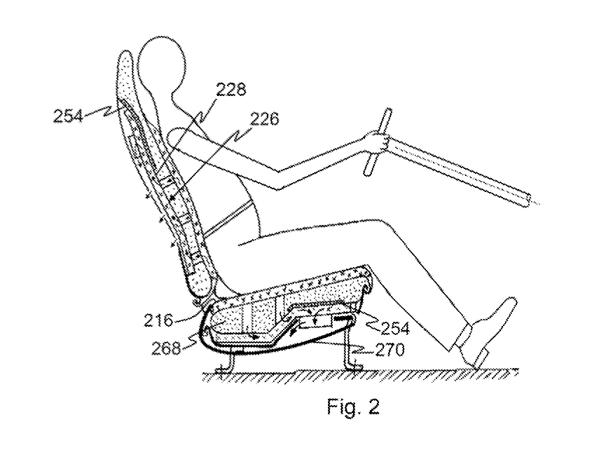

The seating comfort system 110 further includes a noise suppressor 154 such as a noise suppression layer or similar that is generally disposed between the diffuser bag 126 and the rear, B-side 124 of the foam bun 118, and that is adjacent, attached to and/or integral with the A-side 128 of the diffuser bag. In the embodiments shown in FIGS. 1, 1A, 5, and 6, the noise suppressor 154, 554, 654 is disposed inside the diffuser bag 126, 526, 626 (along the inner surface of the occupant facing side of the diffuser bag) between the spacer material 136, 536, 636 and the occupant facing A-side 128, 528, 628 of the diffuser bag. Alternatively, the noise suppressor 254, 354, 454 may be attached to or integral with an outer surface of the occupant facing A-side 228, 328, 428 of the diffuser bag 226, 326, 426 as shown in FIGS. 2, 3, and 4. The noise suppressor may be adhered, bonded, sewn or welded onto the A-side of the diffuser bag or may be attached to the diffuser bag only in specific locations. In the case that the noise suppressor is disposed outside of the diffuser bag, the noise suppressor may alternatively be secured to the foam bun or foam-reinforcing metal wires or other structural support of the bun such as by Hog Rings 356, 456 or other similar fasteners as shown in FIGS. 3 and 4. In yet another alternative, the noise suppressor may substitute for and/or form at least a portion of the A-side of the diffuser bag.

The noise suppressor 154 is usually disposed intermediate the seat occupant and the air mover. The noise suppressor is positioned so that its location generally coincides with (overlaps) the location of the air mover 140 and also may coincide with any passage/conduit/ductwork connecting the air mover to the air mover port of the diffuser bag. Hence, the noise suppressor overlaps (in a direction from the front of the seat toward the back of the seat or vice versa) the air mover footprint. The noise suppressor is also mounted on a side of the diffuser bag 126 that is opposite the air mover 140 so that the noise suppressor does not block flow of air between the air mover and the diffuser bag. The noise suppressor may extend to the top edge of the diffuser bag 126, and may be approximately coincident with the right and left side edges of the diffuser bag, and may be above the one or more vent openings 130 in the diffuser bag. The noise suppressor is thus coupled with the diffuser bag in a maximum noise emission zone of the seat conditioning assembly 110. If the noise suppressor is alternatively located on the outside of the diffuser bag, the noise suppressor may protrude beyond the outer peripheral edge of the diffuser bag, because the diffuser bag is typically smaller in area than the occupant contact surface area of the seat that it serves.

The noise suppressor is preferably continuous (no holes or void spaces) since any voids may allow noise to pass through. However, the noise suppressor may be an increased density porous material having noise suppression properties. The noise suppressor may include one or more sublayers. For example, a single layer or sublayer 358 is shown in FIG. 3, and two sublayers 458, 460 are shown in FIG. 4. Also, the noise suppressor may include higher density continuous sublayers spaced by porous or non-woven felt or fabric sublayers. The noise suppressor preferably has a density per unit area (kg/m², lb/ft², etc.) exceeding one of the planar materials typically used in the seat construction such as felts, fabric, or leather. The noise suppressor may be, but is not limited to, a planar configuration (sheet-like or stack of sheets). The thickness of the noise suppressor may be varied and may be determined arbitrarily based on the individual application and the material chosen for the noise suppressor; however, generally a greater thickness will provide a greater amount of noise suppression. The noise suppressor therefore does nominally increase the thickness of the diffuser bag/seat conditioning assembly, while also avoiding any additional ductwork or space requirements that would be necessary for other noise suppression devices such as a muffler.

Examples of materials forming the noise suppressor include but are not limited to a solid material such as steel but more preferably a pliable material that is compatible with the other materials of the seat conditioning assembly such as one or more layers of a rubber, linoleum, elastomer foil, mineral-filled elastomer, or similar. In one embodiment, the noise suppressor may include three 180×180 mm polyurethane film sublayers each having a thickness of 1 mm and having a matte surface. This exemplary noise suppressor has an equivalent density of 3.5 kg/m².

In use, the noise suppressor absorbs and/or partially redirects air mover noise and vibration away from the occupant contact side of the seat. The noise suppressor therefore significantly reduces the audible fan noise that can be heard by a seat occupant. This avoids relocation of the air mover to an area that is more removed (spaced farther) from the occupant contact surface but less practical in terms of air mover performance and simplicity of construction of the seat conditioning assembly.

It has been previously unknown to place such an increased density noise suppressor between the air diffuser or its spacer material and the seat cushioning element (foam bun/pad) B-side surface. It has also been unknown to place the noise suppressor adjacent to either side of the outer layer of the air diffuser or to incorporate or substitute the material of the outer layer of the air diffuser in this location so that it overlaps at least the air port that provides fluid communication between the spacer material and the air mover, but more preferably overlaps the entire air mover. If the air mover is mounted distant from the air port and an air conduit is used to deliver (or pull) air then overlapping only the air port may be sufficient for noise suppression (see, for example, FIG. 6).

The layers of the system, including the perforated trim cover 516, the air-permeable spacer material 514, the cushioning element (foam bun) 518 including air passage through holes 520, the ventilation diffuser bag 526 including a single vent opening 530 providing airflow to (or drawing air from) the through holes in the cushioning element, the noise suppressor 554 and air-permeable spacer material 536 within the diffuser bag, the annular gaskets 552, the air mover mounting bracket 544, and the air mover 540, are shown in exploded cross-section in FIG. 5. In the arrangement shown in FIG. 5, the noise suppressor 554 is disposed inside of the diffuser bag 526, which is preferable if the noise suppressor can still be made large enough to significantly overlap the air mover port, the entire air mover or an air/vacuum supplying conduit attached to the air mover port of the mounting bracket. Also, as shown in FIG. 5, the air mover mounting bracket may have mounting holes 562 for the air mover that include indentations (bosses) 564 that offset (protrude towards) the air mover to prevent the fasteners for the air mover and/or vibration insulating grommets (not shown) from penetrating into or otherwise interfering with the annular gasket.

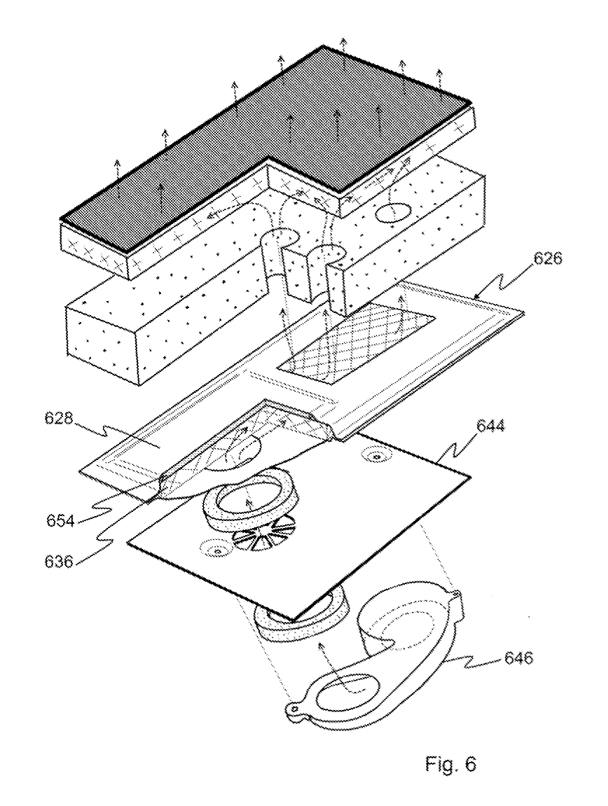

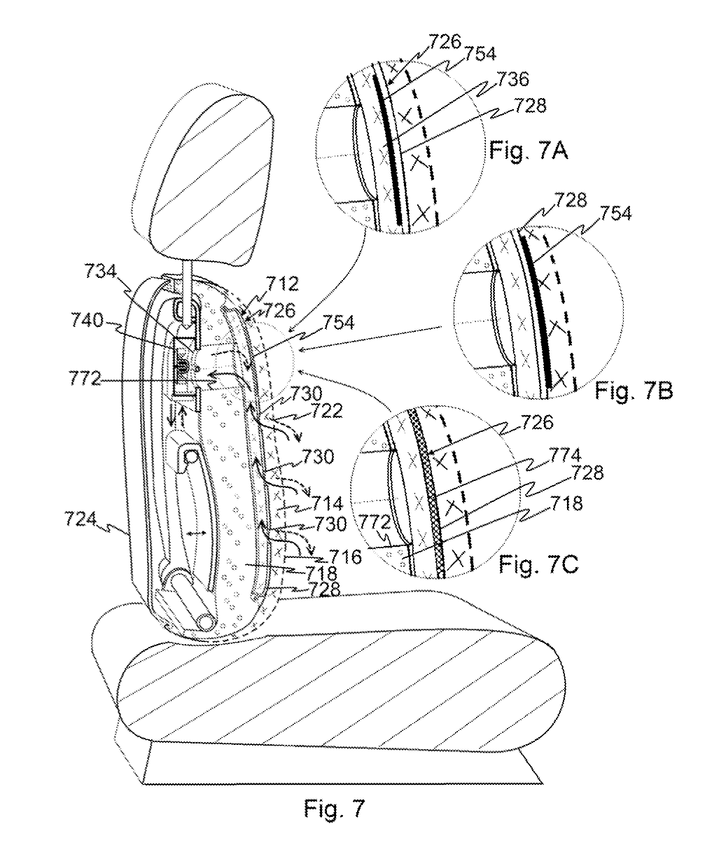

In yet another embodiment shown in FIG. 7, the diffuser bag 726 of the seat conditioning assembly 712 is mounted on the front, occupant facing A-side 722 of the seat. The air mover 740 communicates air from the front, A-side 722 of the seat and the rear, B-side 724 of the seat via a through hole port or conduit 772 in the seat cushioning element 718. In this embodiment, the air mover 740 is mounted on the rear, B-side 724 of the seat and is in communication with the air mover port 734 of the diffuser bag 726 through the port 772 in the cushioning element 718. The air mover 740 may be reversible such that the air mover can either blow air from the B-side 724 of the seat through the port 772, out the A-side openings 730 in the diffuser bag, and through the front side permeable layer 714 and trim cover 716 (shown by dashed-line arrows), or can suck air from the A-side 722 of the seat into the openings 730 in the diffuser bag, out the air mover port 734, and through the port 772 to the rear B-side of the seat (shown by solid-line arrows). The noise suppressor 754 is mounted on the occupant facing A-side 728 of the diffuser bag 726 so that, as in the other embodiments, the noise suppressor is disposed between the air mover 740 and the occupant facing A-side 722 of the seat. In one arrangement shown in FIG. 7A, the noise suppressor 754 is mounted on the inside surface of the occupant facing side 728 of the diffuser bag, and disposed between the occupant facing side and the inner spacer material 736. In another arrangement shown in FIG. 7B, the noise suppressor 754 is mounted on the outside surface of the occupant facing side 728 of the diffuser bag. In yet another arrangement shown in FIG. 7C, instead of being a separate member attached to the diffuser bag 726, the noise suppressor 774 is integrated into the occupant facing A-side 728 of the diffuser bag. This can be accomplished by spraying one or more of the previously discussed compositions, such as a reactive or thermoset polymer, elastomer or other similar material, with or without an added filler, onto at least one surface (inner and/or outer) of the occupant facing side of the diffuser bag, at least in a zone that overlaps or shadows the air mover or the port 772 through the seat cushioning element 718. Alternatively, a polymer or other hardenable or polymerizing substance in liquid form may be applied to at least a portion of the A-side 728 of the diffuser bag by spraying or pouring the substance onto the diffuser bag or by soaking the diffuser bag in the substance (at least partially saturating the bag with the substrance), followed by hardening, setting, or polymerization of the substance, making this portion of the A-side of the diffuser bag a higher density material.

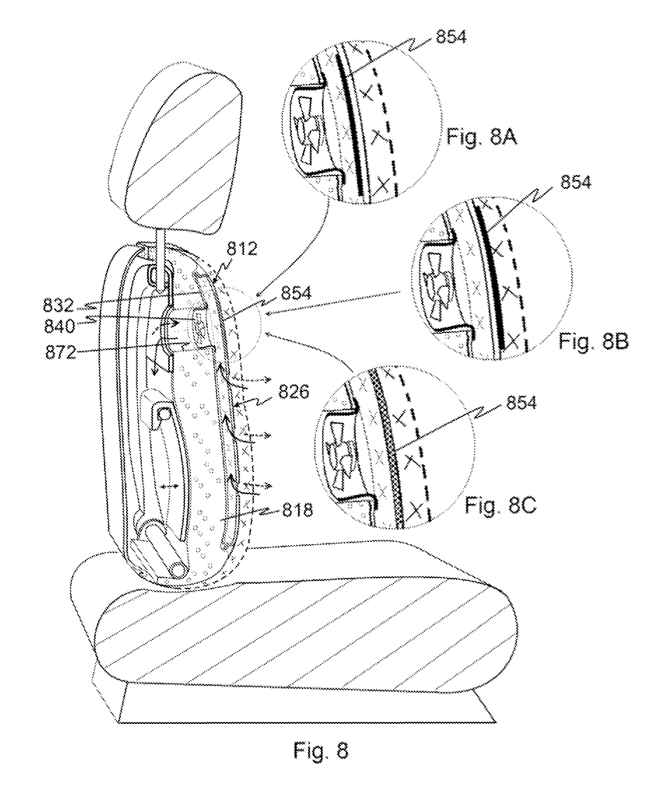

In yet another embodiment shown in FIG. 8, the air mover 840 of the seat conditioning assembly 812 is mounted on and connected to the rear facing B-side 832 of the diffuser bag 826 and disposed in the through hole port 872 in the seat cushioning element 818. The seat conditioning assembly 812 otherwise has the same structure and function as the seat conditioning assembly 712, and the arrangements of the noise suppressor 854 shown in FIGS. 8A, 8B and the noise suppressor 874 shown in FIG. 8C are the same as the arrangements shown in FIGS. 7A-C.

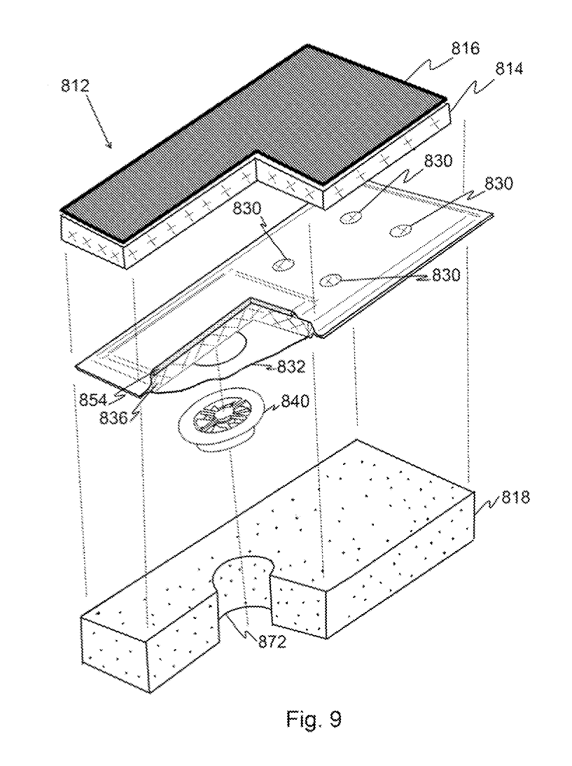

As shown in more detail in FIG. 9, the seat conditioning assembly 812 includes the perforated trim cover 816, the air-permeable spacer material 814, the ventilation diffuser bag 826 including a plurality of vent openings 830 providing airflow to (or drawing air from) the trim cover 816 and spacer material 814, the noise suppressor 854 and air-permeable spacer material 836 within the diffuser bag, and the air mover 840 mounted on the outside surface of the rear side 832 of the diffuser bag and mounted in the through hole port 872 in the cushioning element (foam bun) 818.

One application of the invention, as shown in FIG. 1, is in the back rest of a vehicular seat. Many vehicular seat back rests have space on the rear side of the seat in which the air mover 140 may be installed above the power lumbar device 166. Also, an occupant of the seat hardly touches the seat upper quarter and ventilation passages are not required in the cushioning element (foam bun) in this zone. However, this location is in relatively close proximity to the seat occupant's ears, so noise from an air mover is more likely to be heard by the occupant and/or may be heard at a greater volume than if the air mover were located in a different location. The noise suppressor 154 suppresses air mover noise and/or vibration when an air mover is mounted in the upper region of a seat back rest as shown in the drawings.

However, as shown in FIG. 2, the invention may also be applied to the seat cushion of a vehicular seat (in addition to the backrest of the seat), i.e. a noise suppressor 254 may also be included in the seat cushion on which an occupant sits. Also, as shown in FIG. 2, in another embodiment, the seat cushion 268 of a vehicular seat may include an additional noise suppressor 270 that covers at least a portion of the seat assembly components on the underside (B-side) of the seat cushion. In the embodiment shown in the drawings, the additional noise suppressor 270 is a layer of foam material that is attached to a flap of the existing trim cover material 216. However, other materials of construction for the additional noise suppressor are within the scope of the invention. The additional noise suppressor extends the length of the existing flap and further blocks air mover noise from escaping from underneath the seat cushion.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A seat conditioning assembly comprising:
a ventilation diffuser bag having an A-side and an opposite B-side;
an air mover in fluid communication with said B-side of said ventilation diffuser bag; and
a noise suppressor disposed adjacent said A-side of said ventilation diffuser bag, said noise suppressor overlapping a location of said air mover in a direction from said A-side to said B-side.

2. The seat conditioning assembly of claim 1, wherein said noise suppressor is mounted inside said ventilation diffuser bag.

3. The seat conditioning assembly of claim 1, wherein said noise suppressor is mounted on an outer surface of said ventilation diffuser bag.

4. The seat conditioning assembly of claim 1, wherein said noise suppressor is integral with said A-side of said ventilation diffuser bag.

5. The seat conditioning assembly of claim 1, wherein said noise suppressor is formed by applying a noise suppression material in liquid form to a portion of said A-side of said ventilation diffuser bag, followed by hardening, setting, or polymerization of the noise suppression material.

6. The seat conditioning assembly of claim 1, wherein said noise suppressor is a planar member.

7. The seat conditioning assembly of claim 1, wherein said noise suppressor includes a plurality of sublayers.

8. The seat conditioning assembly of claim 7, wherein said sublayers include polyurethane film.

9. The seat conditioning assembly of claim 7, wherein said noise suppressor includes three 180×180 mm polyurethane film sublayers each having a thickness of 1 mm and having a matte surface, said noise suppressor having an equivalent density of 3.5 kg/m².

10. The seat conditioning assembly of claim 7, wherein said noise suppressor includes alternating sublayers of a high density material and a felt or fabric layer.

11. The seat conditioning assembly of claim 10, wherein said high density material is one or more of steel, rubber, linoleum, elastomer foil, a mineral-filled elastomer, and polyurethane.

12. The seat conditioning assembly of claim 1, wherein said air mover is connected to said B-side of said ventilation diffuser bag.

13. A seating comfort system comprising:
a seat cushion having an occupant facing side and an opposite rear facing side;
a ventilation diffuser bag disposed on said rear facing side of said seat cushion;
an air mover connected to said ventilation diffuser bag; and
a noise suppressor disposed intermediate said rear facing side of said seat cushion and said air mover;
wherein said noise suppressor overlaps a location of said air mover in a direction from said occupant facing side of said seat cushion to said rear facing side of said seat cushion.

14. The seating comfort system of claim 13, wherein said noise suppressor is mounted on an outer surface of said ventilation diffuser bag.

15. The seating comfort system of claim 13, wherein said noise suppressor is mounted inside said ventilation diffuser bag.

16. The seating comfort system of claim 13, wherein said noise suppressor is integral with said A-side of said ventilation diffuser bag.

17. The seating comfort system of claim 13, wherein said noise suppressor is mounted on said rear facing side of said seat cushion.

18. The seating comfort system of claim 13, wherein said noise suppressor has a greater density per unit area than other members of the seating comfort system.

19. The seating comfort system of claim 13, wherein said noise suppressor includes one or more of steel, rubber, linoleum, elastomer foil, a mineral-filled elastomer, and polyurethane.

20. The seating comfort system of claim 13, wherein said ventilation diffuser bag is mounted on one of said occupant facing side and said rear facing side of said seat cushion.
